(19) United States
(12) Patent Application Publication
(10) Pub. No.: US 2016/0366459 A1
(43) Pub. Date: Dec. 15, 2016

(54) METHOD AND SYSTEM FOR MANAGING AND STREAMING VIDEO

(71) Applicants: Dmitry E. Kochman, Buffalo Grove, IL (US); Maxim B. Stolyarov, Northbrook, IL (US); Sergey A. Shlyapintokh, Buffalo Grove, IL (US)

(72) Inventors: Dmitry E. Kochman, Buffalo Grove, IL (US); Maxim B. Stolyarov, Northbrook, IL (US); Sergey A. Shlyapintokh, Buffalo Grove, IL (US)

(21) Appl. No.: 14/736,241

(22) Filed: Jun. 10, 2015

(51) Int. Cl. H04N 21/2743; H04N 21/262; H04N 21/61; H04N 21/472; H04N 21/81; H04N 21/239; H04N 21/482

(52) U.S. Cl. CPC H04N 21/2743; H04N 21/2393; H04N 21/26258; H04N 21/26283; H04N 21/4825; H04N 21/47202; H04N 21/47211; H04N 21/812; H04N 21/6125

(57) ABSTRACT

A method and system for managing streamed videos is disclosed. The system allows video owners to upload videos to a network connected video repository. Channel creators are able to select videos which have been uploaded to the network connected video repository and create custom designed channels. A play schedule is created, either by the channel creator or by an automated system. Viewers of channels may access the channel online. Accessing the channel allows video to be streamed based on the play schedule, individually to each viewer. Video is streamed according to the play schedule and when the channel viewer accesses the channel. Various advertisement based compensation systems are used to compensate channel creators and video owners.

### BACKGROUND OF THE INVENTION

Field of the Invention

The present invention relates to methods and systems for managing streamed video, and more particularly, to a method and system for allowing online channel creators to create schedule controlled play lists and stream video content to viewers.

Background

Video content, for many years, has been conventionally delivered to viewers via live broadcasts. Television channels are delivered to viewers' television sets via airwaves, cable, satellite, via mass broadcasting. Viewers are accustomed to tuning into channels on a television set and watching whatever programming is currently being broadcast.

Because of the structure of this conventional paradigm, generally a small number of established companies have the ability to assemble video content and provide the content on various channels. Additionally, the content is generally provided by well-established and well-funded video content producers.

In recent years, alternatives to viewing video content have been provided to viewers via the internet. Various popular web sites provide digital media content on demand to consumers of the media who select a particular video selection to be viewed. This has enabled a much larger number of video content producers, regardless of size and funding, to make video content available to the public. However, in order to view such video selections, a consumer must actively search for and find a video of interest, and click or select it for viewing.

Various technologies have been developed as tools for providing video to the public online. For example, U.S. Pat. No. 8,117,545 issued to Rosenbaum et al. discloses a hosted video discovery and publishing platform. A channel can be created, for example, according to subject matter, however, a user must search for and bring content into the channel. The viewer would then have the ability to select from various videos within the channel. Viewers must still take active steps in order to view content, including thinking about what type of video to find, searching for such a video, and starting the video.

U.S. Pat. No. 8,925,005, issued to Scott et al., discloses a method of creating a custom content channel. However, this requires a set top box connected to a television. Viewers still must select the desired video content from a list.

None of the prior technologies provides an effective way to manage video content in a way which opens video production and channel creation to the creative public, or which provides viewers with a simulated broadcast experience with respect to such channels. Thus, the need remains for a system and method to enable a broadcast-like experience without an actual broadcast, and a way for a broad spectrum of video producers, channel creators, and viewers to interact.

### SUMMARY

The present invention is a system and method for managing and delivering video content. The system may be implemented in the form of a web site or a client side application running on a client computing device that is integrated with a system server. System users, including but not limited to video content producers or owners, channel creators, and viewers, create unique eco-system for creating, sharing, and consuming video content. This platform produces a unique video experience online.

In this system, video producers of all types are able to provide videos and potentially profit from doing so. Content may come from well-established video producers, as well as any individual or establishment who wishes to make available a video. Similarly, those who wish to create channels by assembling video content, based on whatever criteria they wish, may do so.

For clarity, the following terms require definitions and are used herein as follows. The term “video” includes but is not limited to a sequence of visual images, with or without audio, processed electronically into an analog or digital format and displayed on a screen with sufficient rapidity as to create the illusion of motion and continuity. The term “video streaming” or “streaming” includes but is not limited to a one-way video data transmission from a video data provider over a data network that is constantly received by and presented to a single end-user. This includes a method of partially downloading and then playing video content on an end-user device while the rest of the video is being downloaded. The term “video broadcasting” or “broadcasting” includes but is not limited to the simultaneous distribution of the same video content to a dispersed audience. In other words, it is the spreading of a specific video content or signal over a wide area to all connected devices. The term “video store” includes but is not limited to any interface and process that functions as a video marketplace. This marketplace allows any user to list video content to be for sale or rental or use, either for a fee or not. It also may allow any user to rent or buy the rights to any of the content that is listed on the marketplace. This marketplace is not currency specific, meaning any payment currency can be used, including but not limited to legal tendered currency, a point system, credit or barter system. The term “video library” or “video room” includes but is not limited to an area with digital access to a collection of digital media, such as videos, which a user has uploaded or linked to. Such a collection of videos or links to such videos can be located or stored in a video library by the system user for further management, personal use or use on their online video channel or be offered for rental or purchase on a video store. The term “channel creator” includes but is not limited to any system user, whose intention is to create a video channel or station or network or any other video streaming directory for further distribution of one or more videos to viewers of the channel or other video streaming directory. The term “video owner” includes but is not limited to any system user, who has acquired legal rights to use, sell, rent or otherwise distribute video content over any network and any media to other users or viewers. Finally, the term “network connected video repository” includes but is not limited to a video store or a video library or any video storage, management or distribution place, where video can be located for further consumption, management or distribution by any system user, such as a video owner or channel creator or viewer.

In general terms, the system and method, in their various embodiments, work as follows. Video producers may upload videos to the video library. The term “video” is used herein to refer to any video content, with or without an audio component. Videos uploaded by producers to video libraries can become listed in an online video content store. Those who wish to create video content channels (referred to herein as “channel creators”) may visit the online video store. The video content may be offered to channel creators either at no charge, or for a fee. Channel creators may then select one or more videos to be viewed on their channel. Multiple channels may be created by a single channel creator.

Once a channel creator has selected one or more videos to be played on a channel, a viewing schedule can be created. In other words, channel creators can assemble together various video content selections to be part of a scheduled playlist to be accessible by any user for viewing on a specific date and time on a specific channel. A custom viewing schedule may be created by the channel creator. Alternatively, the channel creator may choose to have an automated system to manage playlist creation and scheduling of various video content selections that is part of the channel or channels using a proprietary algorithm.

Advertisements may be set up to be played between or at various points within the videos. A revenue sharing system may be provided so that revenue generated by the viewing of the advertisements can be shared. For example, a portion of the revenue generated from viewed ads might be transferred to a channel creator account, another portion to a video owner or producer account. Optionally, such revenue may also be shared with the host of the site providing the system.

One key distinction between the present invention and existing web site technologies is the viewer experience. Instead of searching for and selecting a video to view on demand, sometimes referred to as “click to play,” the present invention provides the viewer with an experience in which scheduled programming automatically plays on a channel and is viewed, but without the need for actual broadcasting. Thus, just as a viewer watching television may tune into a selected channel and watch programming which is played according to a schedule, the viewer may visit an online channel which is not actually broadcasting live, and watch the scheduled video content as though the content were started according to the channel schedule. So, if a viewer visits the channel at the scheduled start time for a particular video, the viewer will see that video from the beginning. If the viewer visits the channel at a time after the scheduled start time of a video, the viewer will see the video starting at a point in the video which corresponds to the actual time at which the viewer visited the channel, which could be part way through the video.

This viewing experience removes various levels of active thought and action for the viewer and creates an experience which the viewer is accustomed to when watching conventional television, but without actual broadcasting. However, the system opens up the experience to a much wider range of channels and video content not available to the viewer in a conventional system. Furthermore, it provides the opportunity to video producers and channel creators to share their creative works with the public, even if those producers and creators might not have the resources to participate in a conventional broadcasting system.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a chart illustrating one example of a viewer's experience with respect to the system of the present invention.

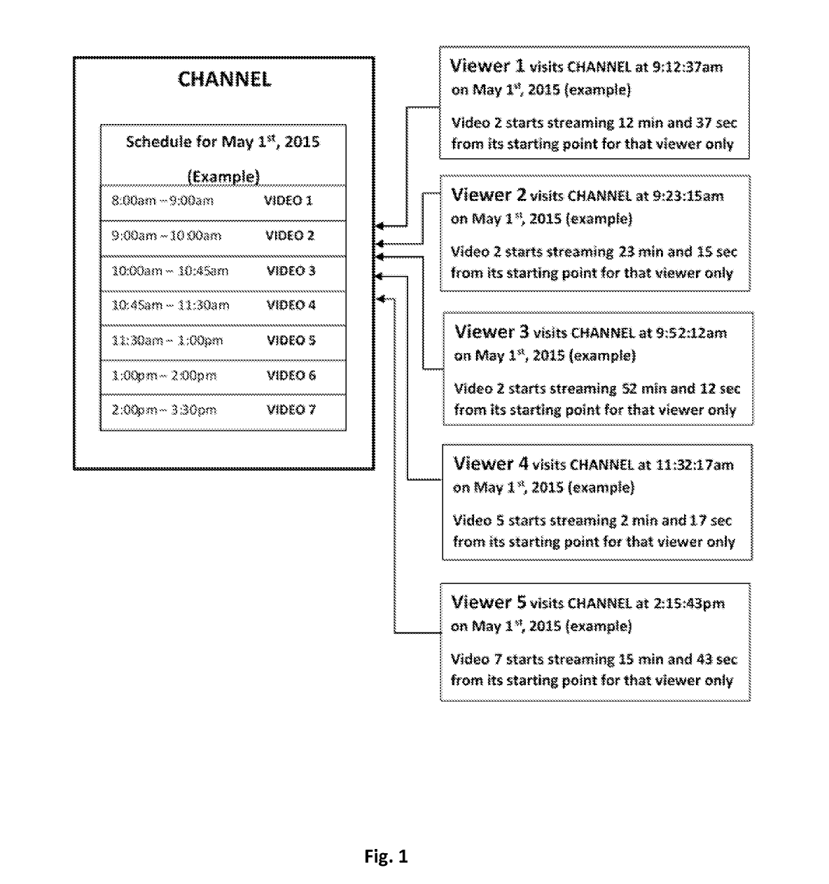

FIG. 2 shows a flow chart illustrating an example of collaboration between a video content owner and a channel creator for the purpose of making their works available for public consumption according to one embodiment of the present invention.

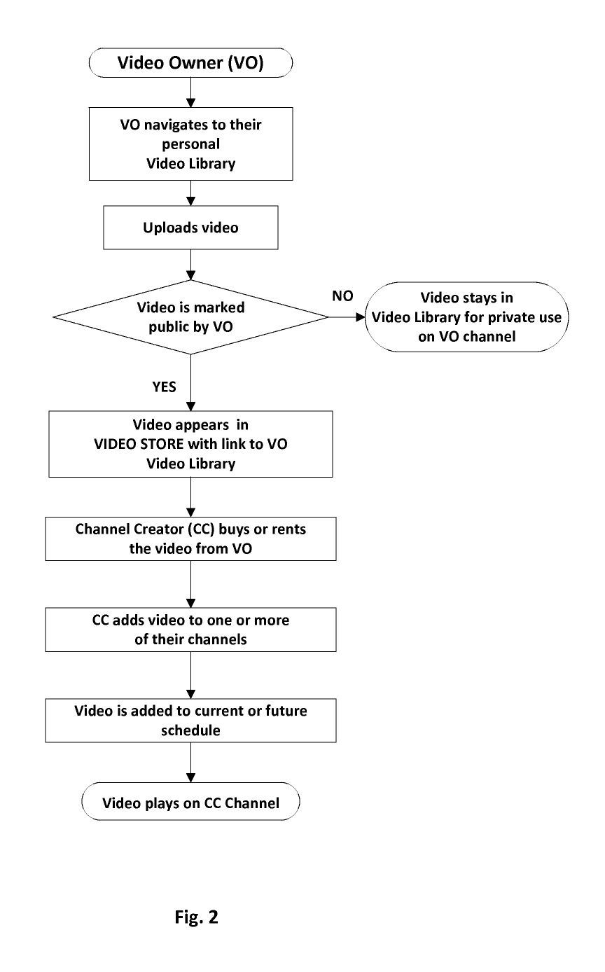

FIG. 3 shows a flow chart that describes an example of the creation of the scheduled playlist by a channel creator according to one embodiment of the present invention.

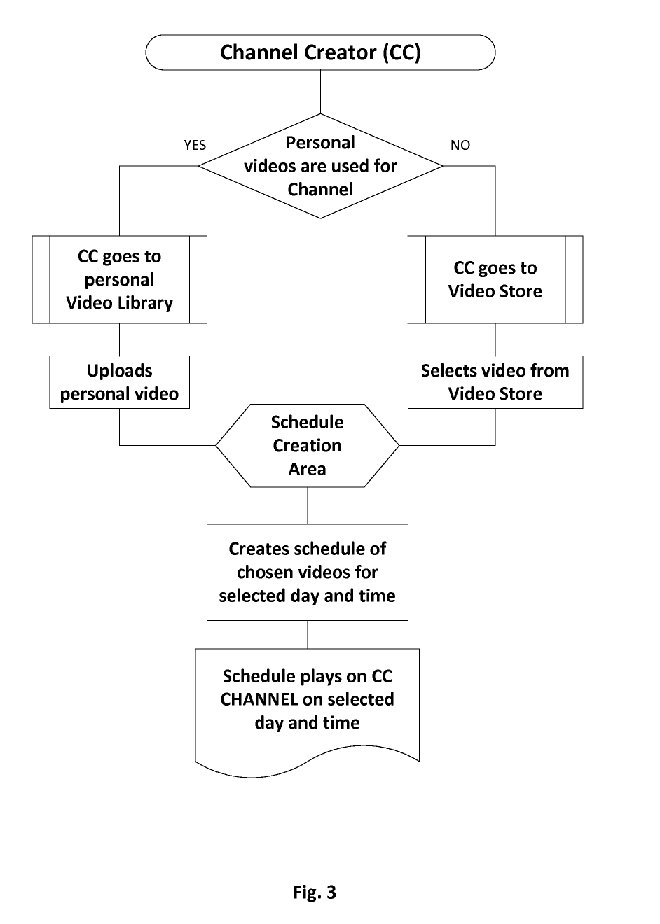

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention includes a method and system for managing streamed video. In its various embodiments, the method of the present invention includes storing first video content on a server computing device, and assigning a scheduled start time for the first video content. The method includes receiving a first request from a first client computing device over a network to view the first video content via such a first client computing device, wherein the first request includes a first request time associated with first actual clock time associated with the first request.

The request received can be generated merely by the viewer visiting the channel or channel page on the client computing device, which may be a computer, tablet, smartphone, smart TV, or any other computing device. The method further includes enabling such a first client computing device to play the first video content beginning at a first start point within the first video content associated with the first actual clock time. In other words, the video portion which should be playing according to the play schedule for the video is transferred to the viewer's device and played as though it started at the scheduled starting time, based on when the viewer visits the channel.

Ideally, the method is in place to support a plurality of users. Thus, the method further includes the step of receiving a second request from a second client computing device over such a network to view the first video content via such a second client computing device, wherein the second request comprises a second request time associated with second actual clock time associated with the second request, and enabling such a second client computing device to play the first video content beginning at a second start point within the first video content associated with the second actual clock time.

As is clear, this enables a viewing experience in which the viewer sees the video as though it started at a scheduled starting time. In certain embodiments, the video begins to play as soon as the viewer visits the channel page, just as one would view a conventional television program in progress by tuning into a channel. For example, if a viewer visits a channel fifteen minutes after the scheduled start time of a video, the video will play content which begins fifteen minutes after the start time of the video, in other words, from the fifteenth minute and further, continuously moving to the next video in line. Thus, the video request is sent by the viewer visiting the channel, and the video is streamed at the proper point in the video automatically.

In various embodiments, the method includes the step of receiving a plurality of videos from video owners. These video owners may be producers of the videos. Video producers or owners can upload videos, regardless of who those video producers or owners are, without many of the restrictions that might apply to them if they were to attempt to engage in business with a conventional broadcasting company. Uploaded videos are stored in a network connected video repository and are available to viewers, channel creators and video owners for viewing and management through a video library or a video store, or both, or any other suitable method of access. A listing of such plurality of videos may be provided in such an online video store with or without access to the video library by producers or channel creators. The list of videos may be provided via the video store or the video library, and may be a general list or a list generated from search criteria. The listing may include titles, identifying information, descriptions or keywords, or any other audio, visual, textual, or graphical information. It may also include a fee schedule for accessing and using the video content.

The method, in various embodiments, further includes the step of enabling a channel creator to access the online video content store, and to select one or more videos chosen from the online video store or an online video library for the purpose of including them in their own channel. Channel creators have broad discretion in how to choose and use videos. Channel creators can create one or more online channels accessible to a plurality of viewers over a network, including but not limited to the internet. Channel creators may also be video content owners with their own video content libraries and use their own video contents on their channels.

In various embodiments, the channel creator is then enabled to create a schedule associated with the one or more videos for playing the videos to viewers. A scheduled playlist may be custom designed by the channel creator, or automatically generated by the system. Preferably, a schedule of continuous play of the content from the one or more videos is created. The schedule can be set up so that it is the same each day, or differs from day to day. The channel creator also has the option of repeating any past, current, or future schedule on any future date and time.

In various embodiments, the channel creator is enabled to have advertisements inserted and played to viewers of the channel, either between videos or between portions of videos, at interruption points during videos, or within videos. Revenue sharing arrangements may be set up so that channel creators and video owners, and potentially viewers, may share in advertisement revenue.

In certain embodiments, the viewer is enabled to alter the play schedule on a channel. Ideally, such a modification would be applicable to that viewer only. Thus, a viewer may be able to rearrange a schedule on a particular channel, effectively creating their own custom schedule.

In various embodiments, networks of channels may be created and associated with one another. It is also understood that channel creators may be allowed to create a plurality of online channels.

In certain embodiments, a channel creator can rent or use a video from the video store or video library and engage in a revenue sharing arrangement. Optionally, the channel creator may be enabled to purchase the video and become the exclusive or non-exclusive licensed owner of the video content.

In certain embodiments, viewers are provided with the ability to select either one or more videos by using search criteria such as keywords, subject areas, or any other search criteria. The videos matching this search criteria may be found in an online video library or the online video store. Videos matching the search criteria may be made available to that particular viewer. Optionally, the viewer may be able to select one or more videos from the list of videos matching the search criteria. Either the entire list of videos matching the search criteria, or the specific videos selected from that list by the viewer, may then be placed in a schedule for that viewer and viewed by that viewer according to the schedule. The schedule may be customized by the viewer, or automatically generated for the viewer.

In various embodiments, the present invention provides various options to advertisers. Advertisers may be provided with various options in placing advertisements. For example, an advertiser may be enabled to choose which channels on which that advertiser may place advertisements. An advertiser may choose channels meeting certain criteria, either by searching using search criteria, or by manually selecting channels. Thus, an advertiser may choose to place advertisements on channels relating to certain subject matter, or based on any other criteria, including but not limited to demographics, geography, subject matter, etc. Advertisers may also be provided with the ability to schedule advertisements by day, date, and time. Thus, an advertiser may choose to place an advertisement scheduled to play on one or more channels of its choosing on a given date and time, or at multiple times or dates. Such scheduling may be done for future playing of advertisements. Such advertisements may be provided in video format, or in any other suitable digital media format.

The scope of the present invention also includes a system for implementing the described method. The system provides for an online video content store where video content owners can offer their work for use to channel creators. Channel creators can use video content available in the video store or video library to assemble content for their channels for the purpose of creating and scheduling various playlists for public consumption to viewers online.

While specific embodiments have been illustrated and described, numerous modifications come to mind without significantly departing from the spirit of the invention and the scope of protection is limited by the scope of the accompanying claims.

What is claimed is:

1. A method for managing streamed video comprising the steps of:
storing first video content on a server computing device,
assigning a scheduled start time for said first video content,
receiving a first request from a first client computing device over a network to view said first video content via such a first client computing device, wherein said first request comprises a first request time associated with first actual clock time associated with said first request,
enabling such a first client computing device to play said first video content beginning at a first start point within said first video content associated with said first actual clock time.

2. The method for managing streamed video according to claim 1, further comprising the steps of:
receiving a second request from a second client computing device over such a network to view said first video content via such a second client computing device, wherein said second request comprises a second request time associated with second actual clock time associated with said second request,
enabling such a second client computing device to play said first video content beginning at a second start point within said first video content associated with said second actual clock time.

3. The method for managing streamed video according to claim 2, wherein the step of enabling such a first client computing device to play said first video content beginning at a first start point comprises causing such a first client computing device to play automatically.

4. The method for managing streamed video according to claim 2, wherein the step of receiving a first request from a first client computing device over a network is accomplished merely as a result of a user on said first client computing device visiting a channel page on which said first video content is listed, and
wherein the step of enabling such a first client computing device to play said first video content beginning at a first start point comprises causing such a first client computing device to play said first video content automatically.

5. A method for managing streamed video comprising the steps of:
receiving a plurality of videos from video owners,
storing said plurality of videos in a network connected video repository,
enabling a channel creator to access a list of said plurality of videos,
enabling such a channel creator to select one or more videos chosen from said list of said plurality of videos,
providing such a channel creator with the ability to create an online channel accessible to a plurality of viewers over a network,
enabling such a channel creator to create a schedule associated with said one or more videos for playing said one or more videos to such viewers.

6. The method for managing streamed video according to claim 5, wherein the step of enabling a channel creator to access a list of said plurality of videos comprises enabling such a channel creator to access such a list of said plurality of videos via a video library or a video store.

7. The method for managing streamed video according to claim 6, wherein visitation of a viewer on such an online channel causes a request to be sent to view a currently scheduled video on such an online channel, and wherein the scheduled video is started at a start time associated with the actual time of the request.

8. The method for managing streamed video according to claim 7, wherein said scheduled video starts automatically upon a viewer visiting such an online channel.

9. The method for managing streamed video according to claim 7, further comprising the step of enabling advertisements to be played to viewers, and providing a revenue sharing arrangement to compensate such channel creators or such video owners or such viewers, or any combination of such channel creators, such video owners, and such viewers.

10. The method for managing streamed video according to claim 8, wherein the step of enabling such a channel creator to create a schedule associated with said one or more videos for playing said one or more videos to such viewers is enabled by enabling such a channel creator to choose to have an automated process create said schedule.

11. The method for managing streamed video according to claim 8, further comprising the step of enabling such a viewer to alter the schedule on the online channel with respect to that viewer only.

12. The method for managing streamed video according to claim 8, further comprising the step of enabling a network of a plurality of channels to be created.

13. The method for managing streamed video according to claim 8, further comprising the step of enabling such a channel creator the option to purchase or rent a selected video from said video store.

14. The method according to claim 6, further comprising the step of enabling a second channel creator to play at least a portion of the one or more videos selected by such a first channel creator on a second channel according to the schedule of such a first channel creator.

15. A system for managing and providing streaming of video online comprising:
a network connected video repository wherein video owners have access to upload videos online to said network connected video repository,
a plurality of channels created by channel creators having accounts associated with said system, wherein said channels are available to viewers online,
wherein, said channels comprise one or more videos selected from said network connected video repository by such channel creators, and said one or more videos are arranged in a schedule for viewing.

16. The system for managing and providing streaming of video online according to claim 15, wherein said network connected video repository is accessible via a video library, and further comprising a video store comprising a list of a plurality of videos stored on said network connected video repository, and wherein said channels comprise one or more videos selected from said video store or said video library by such channel creators, and said one or more videos are arranged in a schedule for viewing.

17. The system according to claim 16, wherein said online channels are configured to enable a viewer to view a scheduled video starting at a point in said scheduled video associated with the actual time of access of the channel by such a viewer via streaming.

18. The system according to claim 17, further comprising an advertisement system configured to place advertisements within such channels viewable by viewers.

19. The system according to claim 18, further comprising a revenue sharing arrangement configured to compensate such channel creators and video owners.
